(19) United States
(12) Patent Application Publication
(10) Pub. No.: US 2007/0288518 A1
(43) Pub. Date: Dec. 13, 2007

(54) SYSTEM AND METHOD FOR COLLECTING AND DISTRIBUTING CONTENT

(76) Inventors: Jeff Crigler, McLean, VA (US); Shawn Dornan, West Newbury, MA (US); Rob Revels, Portland, OR (US); Ben Steinberg, Fairfax, VA (US); Matt Cervarich, Centreville, VA (US)

Correspondence Address: PILLSBURY WINTHROP SHAW PITTMAN, LLP, P.O. BOX 10500, MCLEAN, VA, 22102, US

(21) Appl. No.: 11/744,118

(22) Filed: May 3, 2007

Related U.S. Application Data
(60) Provisional application No. 60/796,932, filed on May 3, 2006.

(51) Int. Cl. G06F 17/00

(52) U.S. Cl. 707/104.1; 707/E17.009

(57) ABSTRACT

A system method is provided for virally distributing content. One or more items of content may be received from a content provider, and the received content items may be packaging in a container. At least one of the packaged content items may be a viral content item associated with a mashing option, where the container of packaged content may be distributed to a distributor. The packaged content may be presented by the distributor using a player application, which displays the mashing option when playing the viral content. The viral content may then be distributed to a user when the user selects the displayed mashing option, wherein additional users can request distribution of the viral content from the distributor or the user by selecting the mashing option.

### CROSS-REFERENCE TO RELATED APPLICATIONS

This application claims priority to U.S. Provisional Patent Application No. 60/796,932, filed May 3, 2006, entitled “System and Method for Collecting and Distributing Content,” the entire disclosure of which is incorporated herein by reference.

### COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright 2007, Voxant, Inc.

### FIELD OF THE INVENTION

The invention relates to a system and method for aggregating, categorizing, expanding, and virally redistributing content.

### BACKGROUND OF THE INVENTION

As broadband Internet access has become more commonplace both at home and in the workplace, the previous drawbacks of online media, including poor resolution and slow delivery, have faded. Convergence of technology in the personal computer and television markets, such as Internet Protocol Television (IPTV), has resulted in a tremendous increase in demand for feature-rich content. This is particularly true for news organizations, journalistic publications, and other content producers or providers, who may wish to make their video, audio, image, print, and other content available to as wide an audience as possible. However, existing systems and methods often fail to fully satisfy the increasing demands in the market for searchable content, among other things.

Existing systems suffer from these and other problems.

### SUMMARY OF THE INVENTION

The invention overcoming these and other drawbacks relates to a system and method for aggregating, categorizing, expanding, and redistributing content.

According to various exemplary implementations, the invention enables various entities (e.g., content providers) to convert content into discoverable media assets for online publication. Content may broadly encompass video, text, audio, images, and other information and data relating to media content. For example, content may be produced by journalistic publications and may include, but will not be limited to, content relating to foreign or domestic events and personalities, financial markets, sporting events, personal interest stories, arts, entertainment, opinions, politics, Web logs (“Blogs”), and other materials. Content may be produced and subsequently distributed in any commonly used form (e.g., text, audio, video, etc.), and may be distributed using commonly used formats such as, for example, streaming video, RSS feeds, and other formats.

Content may be aggregated through the collection of content from primary sources and content providers, such as news organizations, distributors, advertisers, or other sources. The content may then be categorized by analyzing the content to derive descriptive metadata. The content may then be expanded by associating the derived metadata with the content providers, related content, aggregated subsets of content, or in other ways. Related content may then be aggregated and packaged together in a container or play list, with links or copies to the content for redistribution of the content to various users. For example, a play list may include a list of content selections to be played (e.g., broadcast, performance, or otherwise presented for a user). The provision of play lists, containers, and content may be based in part upon the location of a user and the context in which the materials are being displayed.

According to various implementations, the invention may collect content from content providers, review the content of the materials to derive descriptive information, and may provide transcription of content to consumers or other users. In various implementations, the transcripts of the aggregated news may include advertising.

Other objects and advantages of the invention will be apparent to those skilled in the art based on the following drawings and detailed description.

### BRIEF DESCRIPTION OF THE DRAWINGS

FIG. 1 is an exemplary illustration of a system architecture according to various aspects of the invention.

FIGS. 2-4 are exemplary illustration of flowcharts for processing information according to various aspects of the invention.

### DETAILED DESCRIPTION OF THE INVENTION

Overview

News materials, sometimes referred to a “content,” may be distributed by various entities referred to as “content providers”. The content may be provided in various well-known data formats including, but not limited to, images, text, video, audio, and other formats. This content may be captured and stored for further processing and subsequent redistribution. Further processing may include format changes, content analysis, or creation of alternate or additional formats, such as, but not limited to, creation of a transcript. For purposes of this description, a transcript is additional information or meta-data describing or otherwise related to a particular content, generally derived from the content. An example of a transcript is a textual form of audio in the content. Another form of a transcript is editing and play information such as scene and descriptive metadata.

According to various implementations, the news materials may be encoded into content which may take the form of a file, database entry, or any of a number of well-known data formats as would be appreciated. The content may be further described by content metadata, which may identify at least one aspect of the content. In various cases, the metadata may identify at least one aspect of the content discretely. In other implementations, content items may be organized into one or more lists (referred to herein as “play lists”) that enumerate at least one content item (or set of content items), and optionally specify usage rules associated with individual and/or sets of content items. Mashing technology may use the play list to embed a play list or content stream on, for example, a web site (e.g., for viral distribution), where mashing of content may include viral distribution of the mashed content. Content may then be played using a content player, which may comprise any suitable stand-alone or plug-in media player application that plays content on the basis of a play list.

In various implementations, a particular play list or content item may have associated with it one or more content rules specifying how content may be played, distributed, embedded, or otherwise utilized. Rules may take the form of one or more machine-readable instructions used to govern the processing of a play list or piece of content referenced by a play list. For example, a play rule may specify how a particular piece of content may be played by specifying the content to be played or the player to be used. A play rule associated with a particular content item may also specify content that cannot be played proximate to or contemporaneously with the content associated with the rule. Such rules avoid unwanted conflicts in content presentation. For example, a video news story concerning questions about the safety of a product should not be shown on the same screen as an advertisement for that product. Additional rules may be specified as needed to meet particular constraints, as applicable. For example, rules may relate to viral distribution of content, where viral distribution may include any suitable mechanism for distributing content, play lists, or containers, where the distribution mechanism need not rely on distributing each instance from any specific source. As such, viral content may refer to any content distributed virally (i.e., without reliance on a specific source).

Content rules may also be associated with a set of content items, rather than a single item, in a similar manner. In other implementations, a machine-readable rule may be textually represented for presentation to a human user.

Architecture and Components

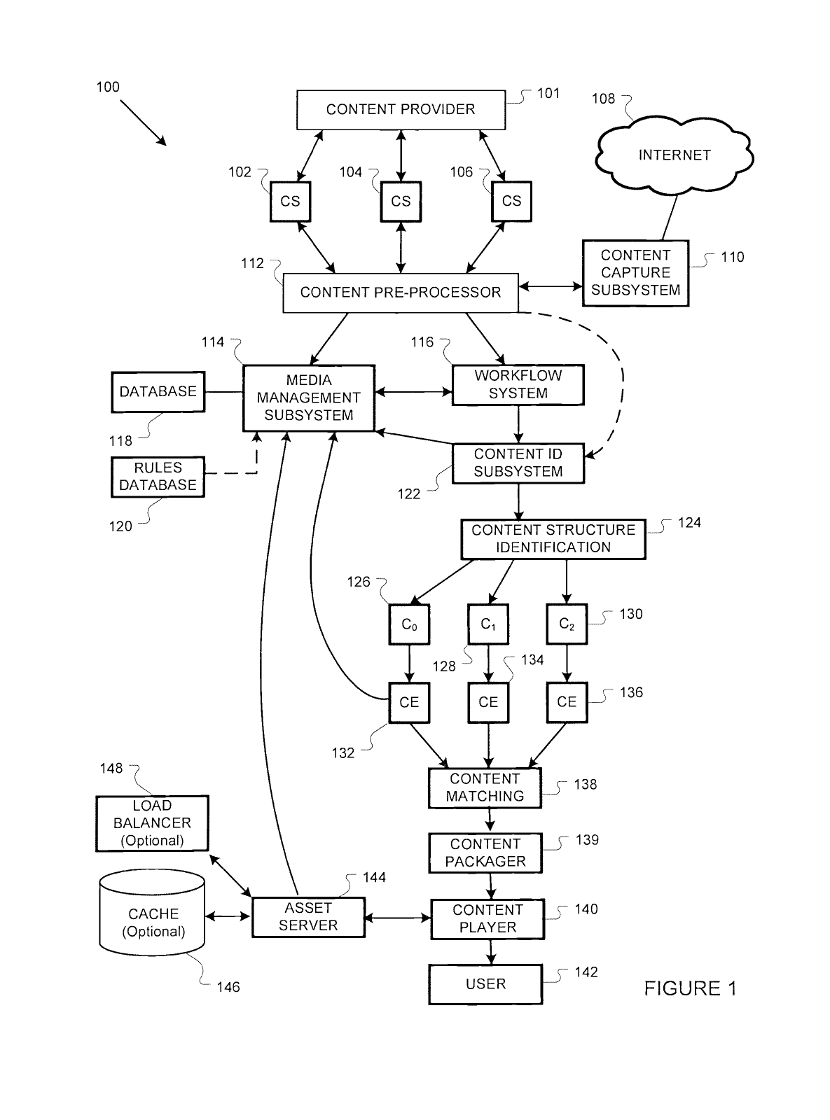

FIG. 1 is an exemplary illustration of a system architecture 100 for providing and disseminating news materials, according to various implementations of the invention.

As depicted, one or more content providers 101 may provide news materials to an open distribution network. In various implementations, the news materials may be associated with specific content rules as they are provided for processing. In other implementations, the content rules may be based on the content provider, the specific content being provided, or an agreement between the distribution network and the content provider. Other configurations may be implemented.

According to an aspect of the invention, at least one of content, content metadata, and rules may be received by a content pre-processor service 112 from content providers 101. Content pre-processor service or subsystem (“CPS”) 112 may optionally send an acknowledgement to the content provider 101 to indicate that the content has been received. CPS 112 may submit the pre-processed content to a content management subsystem for managing and storing content and content metadata. CPS 112 may optionally identify rules previously associated with the received content, and further identifies rules to be associated with the content. Content and content metadata may be analyzed by a content analyzer service that produces additional content metadata related to that content.

In various implementations, content may be stored within a media management subsystem 114 after being received and pre-processed. Media management subsystem 114 may comprise a system for storing, managing, and retrieving content. The media management subsystem 114 may be an asset management system, a video storage system, image storage system, text storage system, database, or other system that can store, manage, and retrieve data, as known and understood by those having skill in the art. In other implementations, media management system 114 may manage content metadata as well as the association of the metadata with content. Alternatively, a separate system may be used to manage content metadata.

After content is stored within the media management subsystem 114, the content may be made available for management and distribution in accordance with one or more rules associated with the content by CPS 112. Based upon rules and metadata associated with each piece of content, content may be published as part of one or more play lists and may be made available to end users in accordance with these play lists. End users may access the content using one or more player applications which operate using one or more play lists.

Components

As described further herein, and with reference to FIG. 1, a system architecture for managing content according to the invention may comprise one or more Content Senders 102, 104, 106; an optional Content Capture Subsystem 110; one or more Content Pre-Processing Subsystems 112; a Media Management Subsystem 114, optionally including a separate rules database 120; a Workflow Subsystem 116; a Content Identification Subsystem 122 (including a Content Structure Identification component 124, one or more Content Enhancement components 132, 134, 136, and a Content Matching component 138); a Content Packager, an Asset Server, a Content Player; and a Mashing application. In various implementations, additional components may also be provided.

Content Sender

With reference to FIG. 1, one or more Content Sender (“CS”) components 102, 104, 106 may be used by at least one content provider 101 to provide content, content metadata, content descriptions, rules, or other information or data to the open distribution network system. CS components 102, 104, 106 may include applications that may optionally be configured as plug-ins for content metadata management software such as, for instance, a video editor. Other content metadata management software may be used as would be appreciated.

In various implementations, a CS component 102 may assign an identifier to one or more pieces of content, content metadata, and content descriptions. Alternatively, a CS component may use an already assigned identifier for one or more pieces of content, content metadata, and content descriptions. CS component 102 may optionally aggregate one or more rules and one or more content descriptions for association with either the content or the content metadata. CS component 102 may then transmit aggregated information to the open distribution network system, where it may be received by CPS 112. In various instances, a single CS component 102 may become overloaded or suffer from degraded performance due to high network traffic or bottlenecks. Each content provider 101 may therefore use one or more additionally CS components 104, 106 to meet bandwidth requirements or improve performance and reliability.

Content Capture Subsystem

According to one aspect of the invention, a Content Capture Subsystem (“CCS”) 110 may be optionally provided that may be implemented in software, hardware, or a combination of both. CCS 110 may capture published content, associate rules with content metadata, and store content, content metadata, and rules to one or more Media Management Subsystems (“MMS”) 114. In various implementations, the functionality of one or more instances of CCS 110 may be integrated with other components of the system. Specifically, instances of CCS 110 may be integrated with instances of the Content Pre-Processing System (CPS 112 ).

CCS 110 may interoperate with Content Sender components, content provider systems such as asset managers, and other content distribution systems as would be appreciated. In various implementations, CCS 110 may capture content “in the wild“from the Internet 108 including, but not limited to, broadcasts, Web outlets, RSS feeds, or other publishing sources.

CCS 110 may further include specific technologies and components that support the capture of specific content feeds or feed formats. One such component may be an RSS feed capture component that receives one or more RSS feeds from a content source, processes those feeds and obtains the content referenced by each RSS feed, and makes that content available for further processing within the CCS 110. Such an RSS feed capture component operates under the control of one or more content capture rules, described in Tables 1-8.

CCS 110 may selectively capture content under the control of one or more content capture rules. Content capture rules may describe content sources, times, search criteria, and other attributes about the content to be captured. Content capture rules may optionally specify further processing of the content once it is captured. Other rules may be specified depending on the nature of the content or any number of factors, as would be appreciated. CCS 110 may forward captured content, content metadata, content descriptions, and the associated rules to CPS 112.

Content Pre-Processing Subsystem

According to an aspect of the invention, CPS 112 may receive content, rules, and content metadata from other subsystems including, for example, CS components 102, 104, 106, a CCS 110, or another CPS 112. The content, rules, and content metadata may be received from the other subsystems using one or more well-known communications methods, which may include a network connection or any other communications methods as would be appreciated.

Content capture rules are a subset of rules that relate to methods and specifications for capturing content from a content provider. Ingest rules are a subset of rules that relate to methods and specifications for processing captured content. Examples of content capture and ingest rules are illustrated in Tables 1-8 using XML fragments. XML is presented for clarity and ease of understanding, and portions not related to the specific description have been removed from the listing for clarity. The content capture rules may be stored and used in other formats on an implementation dependant basis.

The news envelope portion of a content capture rule describes the content sender information within a “News Envelope” element of a particular content capture rule, and may be used further to configure one or more CSS components. The news envelope portion of content capture rules may be omitted in various implementations. In the Table 1 example content capture rule, the NewsEnvelope defines information about a content provider 101 and CS components such as CS component 102. The “ContentSender” portions of a “NewsEnvelope” may include additional information required for the CCS 110 or CPS 112 components to connect with a CS component 102, 104, 106 and receive content, such as authentication information or query definitions. Each of these pieces of additional information may be stored within a specific instance of a content capture rule, an ingest rule, or may be extracted and stored within other portions of the CCS 110, CPS 112, or MMS 114.

TABLE 1
NewsEnvelope XML Example

```
<NewsEnvelope>
  <SentFrom> <Party FormalName=“NewsProvider Name”
  ProviderID=12345 /> </SentFrom>
  <DateAndTime />
  <NewsService FormalName=“Demonstration news service” />
  <NewsProduct FormalName=“Production news feed” />
  <ContentSender URI=”rss://server.com/newsfeed” />
  <ContentSender
  URI=”http://server.com/query.asp?contentID=1234567”
  userID=”demo”
        password=”myPassword”/>
</NewsEnvelope>
```

In various implementations, CPS 112 may receive references or pointers to one or more of the content, content metadata, and rules. In those implementations when references or pointers are used, CPS 112 may follow the reference or pointer to retrieve the content, content metadata, and rules from their actual location.

As content is received and processed by the CCS 110, content metadata used to identify each content is associated with the content. Content capture rules may be used to define each metadata element to be associated with a content. Typically, each of these metadata elements are provided by the CS 102, 104, 106 when the content is provided, or may be determined by the CCS 110 or CPS 112 on the basis of the CS 102, 104, 106 from which the content is provided. Table 2 illustrates an XML example of content identification.

TABLE 2
Identification XML Example

```
<Identification>
  <NewsIdentifier>
  <ProviderId />
  <DateId />
  <NewsItemId />
  <RevisionId />
  <PublicIdentifier />
  </NewsIdentifier>
</Identification>
```

As illustrated in Table 2, an example of metadata associated with a particular content may include numerous elements, including a providerID, a date of the content item, and one or more unique identifiers that may be used to further identify the content during subsequent processing and use. For example, one such unique identifier may be a public identifier such as a DOI, URI, an SGML formal public identifier, a public identifier URN or other public identifier that may be used to access each content at its original source. Alternatively, the identifier used may be one assigned by a component of the system, such as CS 102.

After receiving one or more of content, content metadata, and rules, CPS 112 may restructure these items and associate them with one or more specific instances of content. CPS 112 may optionally transmit a receipt of the content to the originating subsystem, which may include one or more of CS 102, 104, 106, CCS 110, or content providers 101. The receipt may include at least one unique identifier (such as a public identifier or NewsltemlD described above) that may be used by the parties to later identify the specific instance of content, and may take the form of a transaction identifier or content identifier. In the event that plural content, content metadata, and rules are received, CPS 112 may send a plurality of receipts and/or identifiers to the originating subsystem(s). If the content, content metadata, or rules can be uniquely identified, or the capture rules associated with CPS 112 require the content, content metadata, or rules be uniquely identified, one or more unique identifiers may be optionally generated if they do not already exist, and one or more unique identifiers associated with at least one of the content, content metadata, and rules.

In various implementations, if the content, content metadata, or rules cannot be uniquely identified, or if CPS 112 does not require unique identification, previously assigned identifiers may be reused. In various implementations, the unique identifier may comprise a fully qualified Uniform Resource Identifier (“URI”) that uniquely identifies a piece of content.

In various implementations, the unique identifier may comprise a Digital Object Identifier (“DOI”), wherein the unique identifier is assigned by an external registry to persistently identify content and link the open distribution network to the content provider.

In various implementations, the unique identifier may comprise a globally unique identifier generated using algorithms such as the Microsoft GUID or the CORBA UUID algorithms. Other identification mechanisms may be utilized as would be appreciated.

One particular issue associated with managing content, and in particular, with processing new copies of content, is that content providers often republish content, either in identical form, in alternate format, or with minor revisions. In various implementations, the CPS 112 may identify this content based upon information provided by at least one of the content metadata provided with the content, information from the CP 101, CCS 110, CPS, 112 or MMS 114, or from content metadata derived from additional processing such as content analysis. The CPS 112 may create additional content management metadata such as the example content management metadata illustrated in Table 3 to manage the content. In the example in Table 3, content metadata, information identifying when the content was first created, a status of the content, and other information is collected In the Table 3 example, the content has associated metadata that identifies the content as a revision to an initially provided content with unique ID 123456. As would be appreciated, additional content management metadata may be created and managed by a CP 101, CCS 110, CPS 112, and/or MMS 114 as required for specific implementations.

TABLE 3
NewsManagement XML Example

```
<NewsManagement>
  <NewsItemType FormalName=“” />
  <FirstCreated 200601010000 NewsItemID=123456 />
  <ThisRevisionCreated 200701010000 />
  <Status FormalName=“” Revision />
</NewsManagement>
```

The CPS 112 or CCS 110 may construct content management metadata on the basis of materials received from a content provider using a CP 101 or CCS 110. In various implementations, content providers may uniquely identify their content, and provide reference information that links a newly provided piece of content to previously provided piece(s) of content. In various implementations, the content provider 101 identifies the content as being “republished” or as a revision, without a link back to previously provided content. In various implementation, the content provider 101 provides no metadata or other indication that a piece of content has been previously published or that the currently provided content is a revision of a previously provided piece of content. In these implementations, a CPS 112 may search one or more MMS 114 systems for previously provided content with matching metadata, such as an identical or related publisher, title, authors/bylines, metadata, or other information about the content itself.

A CPS 112 may take further actions to distinguish between a particular content provider 101 and the original source of the materials and to record this distinction in metadata associated with a content. Sometimes, a piece of content is provided to the system from an aggregator or syndicator of content and has an original source of the content that is different from that of the aggregator or syndicator. Additional content management metadata may be associated with a piece of content that is provided by a syndicator or aggregator to indicate that the content was created by a first entity and provided to the system by a second entity.

A CPS 112 may further associate specific metadata with a piece of content indicating restrictions and/or requirements on how the particular content may be displayed or provided to users. These restrictions may be embodied in usage rules.

CPS 112 may further identify additional metadata within an ingest rule that is to be associated with a piece of content received and processed by a CPS 112. Table 4 illustrates an XML example of such additional metadata.

TABLE 4
DescriptiveMetadata XML Example

```
<DescriptiveMetadata>
  <Property FormalName=“Vmp Category” Value=“” />
  <Property FormalName=“Asset Type” Value=“” />
  <Property FormalName=“Abstract” Value=“” />
</DescriptiveMetadata>
```

As would be appreciated, additional metadata may be created and managed by a CP 101, CCS 110, CPS 112, and/or MMS 114 as required for specific implementations by using different rules associated with specific types or sources of content, or upon the basis of specific content metadata associated with a piece of content.

Ingest rules may further specify one or more content formats for pieces of content received and processed by a CPS 112. These rules may specify required content types (e.g. content that does not correspond to these requirements is rejected), or may alternatively specify one or more formats to which the content must be converted when it is stored within a MMS 114 and is made available to the system. Table 5 illustrates an example of an ingest rule specification for storing video content specifies the two formats that video content may be stored in within a MMS 114.

TABLE 5
StoreAs Ingest Rule XML Example

```
<NewsComponent>
  <Action StoreAs>
    <ContentItem Href=“”>
      <MediaType FormalName=“Video” />
      <Format FormalName=“video/x-ms-wmv” />
      <Converter />
      <Characteristics>
        <Property FormalName=“Bitrate” Value=“300” />
        <Property FormalName=“FrameRate” Value=“15” />
        <Property FormalName=“Height” Value=“480” />
        <Property FormalName=“Width” Value=“640” />
        <Property FormalName=“Duration” Value=“” />
        <Property FormalName=“Caption” Value=“” />
      </Characteristics>
    </ContentItem>
    <ContentItem Href=“”>
      <MediaType FormalName=“Video” />
      <Format FormalName=“video/x-flv” />
      <Converter />
      <Characteristics>
        <Property FormalName=“Bitrate” Value=“” />
        <Property FormalName=“FrameRate” Value=“15” />
        <Property FormalName=“Height” Value=“480” />
        <Property FormalName=“Width” Value=“640” />
        <Property FormalName=“Duration” Value=“” />
        <Property FormalName=“Caption” Value=“” />
      </Characteristics>
    </ContentItem>
</Action>
```

Each storage specification may optionally specify the converter application and conversion parameters to use as shown above. A system default converter application may also be specified.

As would be appreciated, additional rule-based storage and format conversions requirements may be specified and acted upon by a CP 101, CCS 110, CPS 112, and/or MMS 114 as required for specific implementations

Once the content, rules, and content metadata have been uniquely identified, CPS 112 may communicate with MMS 114, and the content, content metadata, and rules may be stored in at least one MMS 114. Optionally, CPS 112 may notify a Workflow System (“WFS”) 116 of the newly stored content. The notification may take the form of a procedure call, event, electronic message such as an e-mail, SMS, IM, SNMP trap, or other notification mechanism, as known and understood by those having skill in the art. The nature and content of the notification may be specified within the notification software, or may be specified in full or in part by a rule as illustrated by the notify action shown in Table 6.

TABLE 6
Notify Action XML Example

<Action Notify>
<Property mailto:info@notifyaddress.com Subject=”content loaded” />
</Action>

CPS 112 may further communicate with MMS 114 and WFS 116 to ensure that the content, content metadata, and rules are stored, analyzed, and available for use and distribution by the open distribution network.

Usage Rules

The CP 101, CCS 110, CPS 112, MMS 114, and player components 140 recognize and enforce usage rules associated with each piece of content. Each usage rule may be specified within one or more rules, such as an ingest rule, and may be further associated with a specific piece of content as the content is processed. Various examples of usage rules may include, but are not limited to:

Start and end date of content availability—a piece of content associated with these rules is not available before the start date or after a specified end date. The start and end date may be specified as absolute dates (e.g. 1 Jan. 2007 0000 UDT), or as a relative date (+90 days from ingest processing).

Mashability—Individual pieces of content may be set as “mashable” or “not mashable” (e.g., using an XML indicator, such as setting an “isMashable” attribute to “0” when the content is not mashable, or “1” when the content is mashable). A player will not allow user to generate mash embed code for those pieces of content.

Restricted URL—A piece of content may be restricted from being displayed or used from sites associated with specific URLs. The URL may be a fully qualified domain name, or may be a wildcarded domain name (*.mydomain.com) which indicates that all subdomains under and including mydomain.com are restricted).

Address restrictions—A piece of content may be restricted from being displayed or used from sites associated with specific address ranges. An address range may be specified as a fully specified IPv4 or lPv6 address, an address range (from-to), or as a network address specification using a netmask or similar means of specifying a range of addresses (e.g. 10.1.1.0/24).

Location restrictions—A piece of content may be restricted from being displayed or used from sites associated with specific countries or geographic regions. For example, a piece of content may be restricted from being displayed or used from a site hosted in the European Union.

Advertisements—A piece of content may be associated with a particular advertisement, advertising campaign, type of advertisement (e.g. banner, image, video clip), content of advertising (e.g. a car ad), or specific group or types of advertising. Alternatively, a piece of content may be restricted from being associated with any of the above aspects of advertising, including without limitation, a restriction upon any advertising being associated with a piece of content. Advertising rule specifications may further specify the formats of advertising such as location and timing (e.g. during content display, pre-content display, post-content display, left or right of content during display), size, encoding type, and other attributes related to the formatting and display characteristics of associated advertising.

Content branding—A piece of content may be required to be branded in accordance with its source or distribution mechanism. For example, a piece of video content may be required to be overlaid with a particular logo indicating the source of video, in the same manner as network and cable TV stations brand their video today.

Player requirements—A piece of content may be required to be displayed using a particular content player or set of content players.

An example of a rule specifying a start and end date corresponding to content availability for the year 2006 is shown in Table 7.

TABLE 7
Content Availability XML Example

```
<RightsMetadata>
  <UsageRights>
    <StartDate 20060101000000 />
    <EndDate 20061231235959 />
  </UsageRights>
</RightsMetadata>
```

Media Management Subsystem

According to an aspect of the invention, MMS 114 may comprise at least one database 118 configured to save, manage, and retrieve selected instances of content, content metadata, and rules. MMS 114 optionally saves, manages, and retrieves the associations between content, content metadata, and rules. MMS 114 may be implemented using any of a number of databases including, but not limited to, MySQL, Oracle, file systems, or any other storage mechanism. MMS 114 may optionally utilize different storage mechanisms for different instances of content, content metadata, and rules, or a combination thereof. MMS 114 may optionally notify WFS 116 when content, content metadata, or rules are stored in the MMS 114.

In various implementations, content, content metadata, and rules may be associated with one other, and storage and retrieval may be controlled at least in part by various of the rules or content metadata. For example, if a unique identifier is associated with an instance of content or content metadata, MMS 114 may permit the instance of content or content metadata to be stored and retrieved using the unique identifier. Alternatively, if additional content metadata is associated with a specific instance of content, MMS 114 may permit all content instances associated with a specific metadata to be retrieved using the specific metadata as the retrieval key. In various implementations, MMS 114 may include or interface to a distinct rules database 120 that receives rules from at least one source, stores the rules, and makes them available to requesting applications. Rules may be uniquely identified by a specific identifier, or may be composed of a plurality of rules that are assembled to produce a complete rule.

In various implementations, after content has been identified and expanded by the processing of Content ID Subsystem 122, Content Structure Identification component 124, Content Enhancement components 132, 134, 136, and Content Matching component 138, the content may be delivered to a Content Player 140 for redistribution to one or more end users 142.

In various implementations, the output of one or more of Content ID Subsystem 122, Content Structure Identification component 124, Content Enhancement components 132, 134, 136, and Content Matching component 138 may be provided to MMS 114 for storage in database 120. Associations may be made between the expanded content output from one or more of Content ID Subsystem 122, Content Structure Identification component 124, Content Enhancement components 132, 134, 136, and Content Matching component 138 for association with original content in order to provide optimized content, content metadata, and content rules for subsequent uses.

As each piece of content, expanded content, content metadata, or association between two or more pieces of content is stored or updated within MMS 114, the MMS 114 makes a determination of the contents of already published play lists, and containers must be changed. If the MMS 114 makes such a determination, the play list and any containers are regenerated.

Each MMS 114 manages one or more play list specifications with respect to determining whether one or more pieces of content meet the specifications for inclusion in a play list. The play list specifications are provided as rules within MMS 114 and are created and maintained using one or more user interfaces. One mechanisms for managing content to determine inclusion is to score the content, as described below. Thus, only content with specific scores or scores above a specific value are included play lists, or in specific play lists.

Scoring of Content

One aspect of managing content within an MMS 114 is the management of scores associated with each piece of content. Scores provide the basis for the automatic ranking and selection of content for inclusion within one or more feeds, play lists, or other content distribution mechanisms

A first aspect of content scoring is the assignment of mandatory scores. These scores are provided, either by a CS 102, CCS 110, CPS 112, content processing components such as Content ID Subsystem 122, Content Structure Identification component 124, Content Enhancement components 132, 134, 136, and Content Matching component 138, or other components of MMS 114. One or more mandatory scoring algorithms may be used. In various implementations, the mandatory scoring algorithm to be used is selected on the basis of one or more aspects of the content or its metadata.

An example of one such mandatory scoring algorithm is illustrated below.

A first aspect of an exemplar mandatory scoring algorithm is based upon asset type. Studies have shown that video assets are more interesting to end users than audio clips. A score of 4 is assigned to video clips, 3 to textual content, 2 to image content (e.g. pictures), and 1 to audio content.

A second aspect of an exemplary mandatory scoring algorithm considers the provider of the content and their relative stature. This captures that highly respected content providers are more likely to have relevant, interesting content than a home publisher of home movies. In this example, a top commercial provider is assigned a score of 3, a mid-level provider, a score of 2, and other providers a score of 1 or 0.

A third aspect of an exemplary mandatory scoring algorithm considers the age of the content. The score is based upon the “Create Date” metadata element associated with each piece of content. A score of 5 is used for content that is 0-4 hours hold, a score of 4 is used for content that is greater than 4 hours old but less than 12 hours old, etc.

The combination of the scores by asset type, content provider, and content age are combined to produce a mandatory component of the score.

A second aspect of the scoring is based upon opinion of editors or other highly respected individuals. In various implementations, a scoring process may produce one or more scores of this type. Collectively, this group of scores is called editor scores. All pieces of content start with a combined editor score of 0. Each editor may provide one or more scores on various aspects of the piece of content. Various exemplary aspects may include, importance (scaled 0-3), viral quality (scaled 0-3), exclusivity (scaled 0-3), and relatedness (e.g., how a piece of content relates to other pieces of content) (scaled 0-3).

Other aspects of scoring may include the nearness of content to a topic of a play list (e.g. a play list comprising content related to football) or upon the presence or absence of specific metadata.

Other aspects of content may be scored by editors by specifying one or more of the aspects in various scoring rules stored in an MMS 114.

Thus, a piece of content may be scored using the following equation specified by a scoring rule in the MMS 114:
Content Score=1*(Asset Type score)+1*(Content Provider score)+1*(Timestamp score)+1*(Importance score)+1*(Viral score)+1(Exclusivity score)+1*(Relatedness score)

The above scoring rule is an example. Scoring rules may be constructed using any algorithmic expression and combination of values associated with one or more data elements stored within an MMS 114.

Scoring rules may also be constructed that adjust the scaling factor for each scoring aspect (changing the 1 to another value), that add or remove specific scoring aspects to the scoring calculations, or other changes as understood by those skilled in the art. Each scoring rule may be associated with all pieces of content, specific pieces of content, or with all content associated with a specific play list or other group of content.

Editors, based upon their permissions, may be allowed to enter specific types of scores, may be permitted to score specific types or groups of content, or may be otherwise restricted in how they may score content. The rules controlling the scoring activities of each editor are managed within an MMS 114. In various implementations, specific editors may be assigned their own scaling value. Each editors scaling value may be assigned globally or on a play list by play list basis.

In an alternate implementation, any end user may score one or more pieces of content and have their scores stored in an MMS 114 and used to score and rank content. The management of scoring by user is the same as for editors, except that in various cases, end users may be anonymous.

Workflow Subsystem

In various implementations, WFS 116 may be configured to coordinate the expansion and redistribution of content. WFS 116 may expand and redistribute content by coordinating the operation of Content Identification Subsystem 122, Content Enhancement Subsytems 132, 134, 136, and/or Content Matching Subsystem 138 to further enhance received content, rules, and content metadata stored in MMS 114. More particularly, WFS 116 may receive notifications from other subsystems, obtain a specified workflow specification associated with a specific event, and process the workflow to further process content, rules, or content metadata stored in MMS 114. WFS 116 may include a commercial workflow management system available from Microsoft or Adobe as would be appreciated.

Actions of WFS 116 may be controlled, at least in part, on the basis of one or more rules. A simple rule for publishing a piece of content to the NewsRoom is shown in Table 8 as an example of one such rule. If third party commercial workflow management systems are utilized, the parameters to the action may include materials appropriate for controlling each commercial workflow system.

TABLE 8
Publish Content XML Example

<Action Publish>
<Property FormalName=“AutoPublish NewsRoom” Value=“” />
</Action>

Content ID Subsystem

In various implementations, a Content ID Subsystem 122 provides content identification services for the open distribution network. In various implementations, WFS 116 processes a workflow and invokes Content ID Subsystem 122. In various implementations, Content ID Subsystem 122 may be invoked directly by CPS 112. Content ID Subsystem 122 may include a plurality of Content ID Subsystem components, each configured to identify one or more specific types of content. The Content ID Subsystem components may be configured based upon content type, such as video, audio, or encoding type. In various implementations, the Content ID Subsystem components may be configured based upon features of the content itself rather than content type. For example, a Content ID Subsystem component may provide identification of specific items in content, such as vehicles or facial characteristics. In various implementations, a Content ID Subsystem component may be configured to identify content based on a unique identifier, content metadata, content rules, or processing rules defined by the system. The Content ID Subsystem components may be specialized in other manners as needed as would be appreciated.

Content ID Subsystem components may output their findings in a common content metadata format, which in turn may be stored in MMS database 118 and associated with the original instance of content stored in MMS database 118. Content ID Subsystem 122 may invoke various Content ID Subsystem components sequentially or in parallel, upon the whole piece of content or a portion of the content, on the basis of rules, or upon a combination of rules and at least part of the metadata associated with a piece of content.

In various implementations, as each piece of content metadata is created and stored in MMS 114, Content ID Subsystem 122 may optionally create additional rules and metadata to be associated with the newly created content metadata, and may also cause additional rules to be associated with the original content. The newly associated content, content metadata, and rules may be provided to MMS 114 for storage in database 118.

Content ID Subsystem 122 may provide its output to a Content Structure Identification component 124 to process video content, audio content, or a combination thereof. Content Structure Identification component 124 may analyze the incoming content to determine and identify the structure of the content. The structure of content may comprise logical changes, breakpoints, or other characteristics relating to arrangement and organization of the content. For example, in various cases the logical breakpoint may be scene changes as indicated by a substantial change in the content data pattern that indicates a scene change. In various cases, a Content Structure Identification component 124 may identify commercials within a news cast by recognizing a change in data corresponding to the scene. In various implementations, Content Structure Identification component 124 may recognize a change in content volume during the commercial. In various implementations, Content Structure Identification component 124 may be configured to analyze and detect other structural features of content as would be appreciated.

According to one aspect of the invention, Content Structure Identification component 124 may decompose complex or aggregated content to individual content components. For example, content may comprise a recording of a newscast with six distinct segments separated by commercials. Content Structure Identification component 124 may identify scene changes and create metadata that describes the frame number and synchronized date/time stamp for each scene change. In implementations, Content Structure Identification component 124 may identify a plurality of scene changes or an aggregation of structural characteristics of content. Once the structure of content has been identified, Content Structure Identification component 124 may output one or more instances of structured content 126, 128, 130 to one or more Content Enhancement components 132, 134, 136 for further processing.

Content Enhancement components 132, 134, 136 may be configured to further process one or more of contents 126, 128, 130 using content analysis techniques such as speech, scene, or facial recognition. Other content analysis techniques may be utilized as would be appreciated.

In various implementations, a separate Content Enhancement component may be created for each applicable technique. For example, referring to FIG. 1, a first Content Enhancement component 132 may use a speech recognition technique, a second Content Enhancement component 134 may use a facial recognition technique, and a third Content Enhancement component 136 may provide scene rendering. In various implementations, a Content Enhancement component 132, 134, 136 may identify the presence of content overlays, such as “station ID bugs,” wherein a station or content provider identification is merged with the content. Examples of “station ID bugs” may include, but are not limited to, the “Fox” logo merged into the lower right-hand corner of a Fox newscast. Similar Content Enhancement components 132, 134, 136 may be used to identify licensed content in composite images, such as the use of wire service provided images or stock footage.

Content Enhancement components 132, 134, 136 may be used individually, in sequence, or in parallel to identify the audio track of a newscast and to provide a transcript of the news cast as metadata associated with the content comprising the original newscast. For example, in various implementations, outputs from a plurality of similar Content Enhancement components 132, 134, 136 may be compared to produce metadata that describes the content in the aggregate. An example of such an implementation may include the use of a plurality of speech recognition components from different vendors, with the outputs of each Content Enhancement component processed in relation to the output of other components. The output of the Content Enhancement components 132, 134, 136 may be provided to MMS 114 for association with original content in order to improve the final results stored in MMS 114.

The output of Content Enhancement components 132, 134, 136, or other Content Enhancements not shown, may be delivered to a Content Matching component 138 for association with other related content on the basis of content metadata. In an exemplary implementation, Content Matching component 138 may associate related scenes to assemble related scenes to identify logical “stories” in a newscast. Other associations and relations may be identified and matched without departing from the scope of the invention. Content matching component 138 may also provide “content scoring” services, in which specific content is evaluated and scored, and the scores are recorded for later use.

Content Packager

A content packager component 139 is provided that packages one or more pieces of content for delivery to and use by a content player. The content packager component 139 generates a description of the content to be played called a play list. An example of an XML encoded play list is shown in Table 10. Other play list encoding approaches may be used based upon implementation details and the intended use of the play list. Thus, offline play lists may be encoded using techniques that ensure the integrity and privacy of the play list and its contents. In various implementations, this means that a play list may be encrypted for privacy or digitally signed to ensure integrity. In various implementations, the play list may be combined with specific content and/or advertisements and made available to one or more content players.

In various implementations, a user may configure the content the user wishes to have provided in a particular play list or container using a management user interface such as the NewsRoom interface. The specification for the desired content may be stored as rule within an MMS 114, and may be made available to a content packager.

The content packager component 139 identifies the content to be distributed in accordance with the specification contained in at least one rule. The content packager component uses the identification of the content and the identified content's metadata to produce a play list as described below. A play list may be represented in XML, SWF, RSS, or other data representation appropriate for its intended use. In various implementations, the produced play list is stored in a cache or asset server 144.

In various implementations, the play list may include a link to the identified content and/or metadata. In various implementations, the play list may include a copy of the content being distributed. In various implementations, the play list may include both a link and a copy of the content may be included in a play list. It may be useful to include content within a play list so that the play list can be used in an offline usage scenario (e.g. without access to an MMS 114) or when a content is sufficiently small, as occurs in various instances when the content being provided is in textual format. The amount of metadata included in the play list may be determined by the rules used to control the selection of content, metadata, and advertising associated with the play list.

Additionally, in various implementations, a play list may include links to or copies of content that is related to an identified piece of content. For example, if a first piece of content is a preferred story about a topic, and a second piece of content is another story about the same or related topic from a different source, these two pieces of content may be associated as related stories. Depending upon the rule used to select content for a play list, one or more related pieces of content may be identified in a play list. The identified related content may be included in the play list, or a reference to the content may be included in the play list. Related content may be made available by the content player if the user desires to see related content.

Similarly, in various implementations, a play list may include links to or copies of advertising that is related to an identified piece of content. A play list may optionally identify one or more sources of advertising and/or advertising campaign information. Furthermore, rules that restrict the types, size, location, etc. of advertising associated with particular content may also be specified in the play list. Copies of advertising may be included in a play list when the play list may be used by a content player in an off-line mode of operation.

In some other implementations, a content packager component may combine one or more aspects of play list(s), rules, and content in a container. A container may include a play list, content, content metadata, rules, and other information associated with the content. A container may be encrypted or be cryptographically protected. A commercially available container mechanism such as *swf files or OEBPF Containers may be used as the container as would be appreciated. Other container mechanisms and formats may also be used as would be appreciated.

A content packager may be associated with a notification mechanism that causes one or more play lists to regenerate if content, content metadata, or rules governing a specific content change. Thus, if a piece of content is revised and redistributed by a content provider, a notification may be provided by the MMS 114 to one or more content packagers to repackage each play list that is affected by the change.

Asset Server

An asset server 144 may provide a service-based interface for providing containers, content, and play lists to Content Players. In an exemplary implementation, an asset server includes an asset manager service based interface such as web interface, an optional cache in which to store previously generated play lists, an optional load balancer, an interface to at least one MMS 114, and service and utilization logging and reporting.

An asset manager service may be constructed using any service-based implementation methodology. The service interface may be provided using a firewall/proxy server transparent protocol such as HTTP. In various implementations, the service interface may be provided using a commercially available web server such as Apache or IIS combined with a service interface component. The service interface component may provide the following services to Content Players: get content, get play list, and/or report usage. The “Get content” operation of the asset server obtains a specified piece of content from the system and makes it available to the requesting Content Player. The content may be stored in a MMS 114, may be locally cached within the asset server, or may be located on a content providers system.

The “Get Play List” operation of the asset server obtains a specified play list from the system and makes it available to the requesting Content Player. The play list may be stored in the asset server's cache, stored in a MMS 114, or may be generated in response to the request from the Content Player.

The “Report Usage” operation of the asset server permits the submission of log materials to the asset server logs. The “Report Usage” service can accept any rule-defined information from the Content Player. The service interface for the report usage service may be separately defined from the get content and get play list service operations. Alternatively, the service interface may be implemented as part of a URI. An example “report usage” URI is http://voxtest02.voxant.com/playerReporting/submit.htm?v=1&a=123456.

An example of an ad usage report from a particular feed is represented by the following URI:http://voxtest02.voxant.com/playerReporting/v0?a=1234&t=v&f=10&m=135&i=38744323 21&z=r&ad1=1756382&ad2=0&u=http://www.myspace.com/mypage

Table 9 illustrates examples of the information that may be included in usage reports:

TABLE 9
Report Usage information Example

| | |
|---|---|
| v = | version of player (part of path) |
| a = | asset_id (individual asset . . . not a feed) |
| t = | asset_type (i, v, t, a) |
| f = | feed_id (id of feed or playlist) |
| m = | mash_id (will be parent for v0 players) |
| i = | session id (generated by player) |
| z = | action of user (r = “Render” which may be reported when the |
| | player loads the page, v = “View” which may be reported when |
| | the user views a piece of video content or i = “Impression” |
| | which may be reported when the user views a video |
| | advertisement). |

If the reporting action includes reporting on advertising, the
following additional information may be provided:

| | |
|---|---|
| ad1 = | ad id. This value may be 0 if no ad was served |
| ad2 = | ad id.. This value may be 0 if no ad was served |
| u = | url of ad |

If the reporting action includes reporting of scoring information,
the following additional information may be provided.

| | |
|---|---|
| Score = | Score of content identified by asset_id (above). |

An optional cache component of the asset server may be used to provide a local storage mechanism for frequently used content, rules, play lists, and advertising. This cache component may generally be implemented using a disk-based storage mechanism, although other storage mechanisms may be used as would be appreciated. The cache component may be populated by the asset server, management interface, and content packager components of the system, and may be managed by the asset manager component of the asset server.

An optional load balancer may be used to split high processing volume loads across a plurality of asset servers.

The log management component of the asset server may provide for the logging of usage information and subsequent processing of the usage information. This information may include the number of times each piece of content is viewed, the Content Player, play list, web site, and advertising associated with each viewing of the content. Other information may also be collected for use in performance analysis, such as the number of times a piece of content is provided to a Content Player but the content is not shown to a user. The usage information may be processed by the asset server and may be loaded into a database for subsequent review in the management interface. The database may typically be a database 118 associated with a MMS 114 including the specific piece of content.

In various implementations, the log management component receives scoring information associated with one or more Content Player 140. The log management component creates scoring metadata and stores it within an MMS 114.

Management Interface

A management interface, sometimes referred to as a NewsRoom, may be provided to permit editors and other users to manage content in one or more MMSs 114. The management interface may provide on or more of the following capabilities to users of the system: 1) Define play list, play list content and parameters for play lists; 2) Define rules associated with one or more play lists; 3) Identify specific advertising for inclusion in specific play lists; 4) Review and score content; 5) Configure content sources; 6) Review usage information.

In various implementations, a user of the management interface may create and manage specific play lists. The user may create a play list and identify the content the user wishes to include in the play list. The content may be identified by enumeration (e.g. specific piece of content 1, specific piece of content 4), by source or other metadata (e.g. all current events from Reuters), or by user selected query (e.g. all current events from Reuters that don't have video images of violence). The user may also create rules governing the use of the play list, including rules that govern how the play list may be further distributed (e.g. mashing rules), the web sites the play list may or many not be mashed to, geographic distribution limitations, etc. The user may also identify specific advertising that may or may not be associated with the play list.

In various implementations, appropriately permissioned users of the management interface may rank and score specific pieces of content. The rank and scoring information may be stored as metadata associated with the specifically ranked and scored content in a MMS 114.

In various implementations, appropriately permissioned users of the management interface may configure the system to manage the provision of content, the ingest of content, including content enhancement and workflow processing, and other aspects of the operation of the system.

In various implementations, appropriately permissioned users of the management interface may review usage information generated by the asset server.

Play List

Table 10 illustrates an example play list as described herein.

```
<playlist assetId=“F10” playlistExternalId=“” playlistName=“US”>
  <asset type=“text” id=“T226013” date=“Apr 20, 2007” title=“Nation mourns victims of US campus gunman”
      sourceName=“AFP” sourceIcon=“http://cache.thenewsroom.com/provider_graphics/afp_logo_sm.gif”
      sourceLink=“http://www.afp.com” providerName=“AFP”
      providerIcon=“http://cache.thenewsroom.com/provider_graphics/afp_logo_sm.gif”
      providerLink=“http://www.afp.com” mashCount=“” externalId=“070420182802.6dtp197w”
      assetSourceHref=“” externalHref=“” isMashable=“1”>
    <description>Bells tolled across the US Friday as the nation mourned 32 people shot dead at a
        Virginia university and President George W. Bush ordered a review to stop future tragedies.
        The day of religious services and commemorations came amid burning questions
        o...</description>
    <copyright>(c) 2007 AFP</copyright>
    <content author=“” wordCount=“1”><p>BLACKSBURG, United States (AFP) - Bells tolled across the
        US Friday as the nation mourned 32 people shot dead at a Virginia university and President
        George W. Bush ordered a review to stop future tragedies.</p><br><p>The day of religious
        services and commemorations came amid burning questions over how South Korea-born
        student Cho Seung-Hui, who had been treated for mental health problems, was able to buy
        two guns and ammunition.</p><br><p>“We can never fully understand what would cause a
        student to take the lives of 32 innocent people,” Bush says, in remarks released
        Friday.</p><br><p>“What we do know is that this was a deeply troubled young man -- and
        there were many warning signs.”</p><br><p>Top officials from the departments of
        education, justice and health will report to Bush with recommendations on how to avoid
        such tragedies in the future.</p><br><p>Virginia led the country in mourning Friday as in
        bright sunshine, residents emerged from their homes wearing Virginia Tech's trademark
        maroon and orange colors.</p><br><p>About 1,000 people, crowded onto the campus' drill-
        field, bowed their heads in silence as the bells tolled.</p><br><p>Amid the crying and
        hugging, a handful of students released 32 orange and maroon balloons bearing the names
        of each of the dead.</p><br><p>“It was harder than you thought” to release the balloons,
        said Christine Backhus, a senior in pyschology, from Centreville, Virginia, the same town Cho
        called home in the United States.</p><br><p>“You think you've cried it all out, and then's
        more,” she said.</p></content>
  </asset>
  <asset type=“stream” id=“V234806” date=“Apr 24, 2007” title=“Raw Video: Storm Chaser Catches
      Tornados” sourceName=“The Associated Press”
      sourceIcon=“http://cache.thenewsroom.com/provider_graphics/ap_logo_sm.gif”
      sourceLink=“http://www.apdigitalnews.com” providerName=“The Associated Press”
      providerIcon=“http://cache.thenewsroom.com/provider_graphics/ap_logo_sm.gif”
      providerLink=“http://www.apdigitalnews.com” mashCount=“”
      externalId=“0424dvs_ks_tornado_raw_700” assetSourceHref=“” externalHref=“” isMashable=“1”>
    <description>Storm chaser Brandon Ivey catches up with several tornados in Kansas. Officials
        report no injuries or serious damage from the funnel clouds. (April 24)</description>
    <copyright />
    <stream
        url=“rtmp://cp31981.edgefcs.net/ondemand/voxant/ap/2007/04/24/0424dvs_ks_tornado_raw_mx.flv”
        previewImage=“http://cache.thenewsroom.com/ap/2007/04/24/0424dvs_ks_tornado_raw_400×300.jpg”
        thumbnail=“http://cache.thenewsroom.com/ap/2007/04/24/0424dvs_ks_tornado_raw_400×300.jpg” showPreroll=“true” />
  </asset>
</playlist>
```

Other Components

Additional system components, including Web servers, RSS feeds, and other common networking components may be included or incorporated into various implementations of the invention. One such component may include, for example, a Web site interface to an asset server providing one or more play lists or containers making the content available to users of the site.

Content Player

In various implementations, Content Player 140 may comprise a multi-paned media player application that processes a content container. Content Player 140 may operate against one or more containers constructed for on-line use by using the container specification for content and obtaining the content from an asset server or other server on the Internet. In various implementations, Content Player 140 may obtain content and rules from one or more containers directly associated with the open distribution network.

In various implementations, Content Player 140 may interpret and enforce content play restrictions defined in one or more rules associated with the content, as described in Tables 1-8. These rules may limit the ability of Content Player 140 to display certain content in association with specific Web sites, information displayed on a web site, or in association with other content.

For example, a first content provider may prohibit display of their content in association with content from a second content provider. Alternatively, the first content provider may prohibit display of the second content provider's content on Web sites that do not have authorization to display content from the first content provider.

Content Player 140 may enforce rules limiting display based upon authorization by using external authorization tokens associated with Web site providers or DNS names such as digital certificates as evidence of authorization to display specific content as would be appreciated.

In various implementations, Content Player 140 may enforce rules that govern playing of content on adjacent panes. For example, most advertisers do not want their content played: (1) on the same screen as advertisements from their competitors; (2) adjacent to news articles critical of the vendor or industry; or (3) serially on the same screen. Rules can define these relationships, which may then be enforced by Content Player 140.

Moreover, Content Player 140 may be configured to enforce rule with different degrees of strictness or play continuity. In various media outlets, for example, play continuity may be more important than rule enforcement. Content providers 101 may reverse the emphasis and rank rule enforcement more highly. Content Player 140 enables both models (and others) by interpreting the rules and enforcing them in light of content provider, media outlet, and/or user preferences.

In various implementations, exceptions to processing rules may be provided, and may be reported while Content Player 140 is on-line. Any number of rules may be defined as needed, wherein the association of rules and content may vary as described in Tables 1-8.

In an alternate embodiment, a Content Player 140 may provide a link to, or a window to, an online management interface such as the management user interface described above. In a particular alternate embodiment, a Content Player 140 provides a link to, or a window to, a NewsRoom site for management of the content and play list associated with the play list or container currently being processed.

In other particular implementations, a Content Player 140 may operate in an “off line” mode and operate on one or more play lists or containers independently of any online asset server or other server on the Internet. In these particular implementations, the play lists or containers received and processed by a Content Player 140 must be necessarily complete, and include all rules, pieces of content, and advertising materials required for providing the content to an end user. In various implementations, a container may further comprise an instance of Content Player 140.

In an alternative implementation, the user may enter their scoring information in the content player 140. The scoring materials may then be reported to an MMS 114 by the usage reporting mechanism, as described herein.

When operating in offline mode, Content Player 140 is not able to provide usage reports in real time and must deliver the usage reports on an as-available basis. These undelivered reports are stored in ways that make them hard to tamper with, perhaps encrypted and/or digitally signed. The undelivered reports are then delivered when Content Player 140 is next able to make contact with an MMS 114. Alternatively, the Content Player 140 may be specially constructed to send usage reports using whatever communication means is available, such as e-mail, HTTP, or SMS. Content Player 140 's offline reporting behavior is determined based upon the rules included in the package or play list or container. For example, a notify rule may be specified that indicates usage reporting should occur using e-mail.

Interaction with Search Engines

The MMS 114, asset server, and its related web pages publish a commercial news site called Noozilla. Noozilla provides a public web interface through which Internet-based users and systems such as search engines can access the content stored in an asset server.

One aspect of the present invention is the provision of and ranking of content by external content search engines such as Google. One factor in getting search engines to crawl the site and give it a high ranking is that the content must be original, it must be linked to related content, and if possible linked to related sites.

Often, most original content on the static page is the video and its associated content. The video itself may not be unique, but the combination of the video and enhanced content such as speech-to-text transcripts is both unique and interesting. For each piece of content posted to an MMS 114, a static page will be generated to the asset server that comprises the piece of content and provides links to related pieces of content and related web sites.

The static page contains a preview image, title, description, first couple of paragraphs of the transcript or STT, a set of keyword metadata encoded as meta tags, and a list of links to related pieces of content. The static pages may also have links other static pages that allow the search engines to follow the links in order to crawl all of our static pages. The MMS 114 provides the pieces of content, associated content, metadata, and tags for each piece of content.

The preview image on the static page will have a play video button that when clicked will take the user to a distributors site and auto-play the piece of content. So the overall user interaction will look something like:

User searches on a commercial search engine such as Google or Yahoo, and because of our content linkage embodied in the static pages, the user sees Noozilla as a top 5 site. Following the link provided by the search engine. The user lands on the static asset page where they can read the first couple of paragraphs and click on the play video button. The user is then taken to a distributors site where they can view the video, where, after watching the video the user will be shown related content through the distributor's content player.

In a related aspect, the static pages may be associated with one or more distributors. A distributor is a site that provides mashed content as described herein. An MMS or asset server can select which distributor's site to link to, or can select a distributors site to link to from an internally stored list of sites. Each distributors' site has an embedded content player that is made known to an MMS using a well known internet address.

When the user selects content from a static page, the user is referred to the well known address of the selected distributor will include a unique asset id in the URL string that is sent to the content player on our distributor's site with a matching category. The content player is able to dynamically load the content based on the asset id embedded in the URL string. While the ad and content are playing the player will pull in related content to attract the user to stick around. The distributors page will link back to the appropriate Noozilla category page which will improve search engine ranking on both sites.

Process for Viral Redistribution of Content

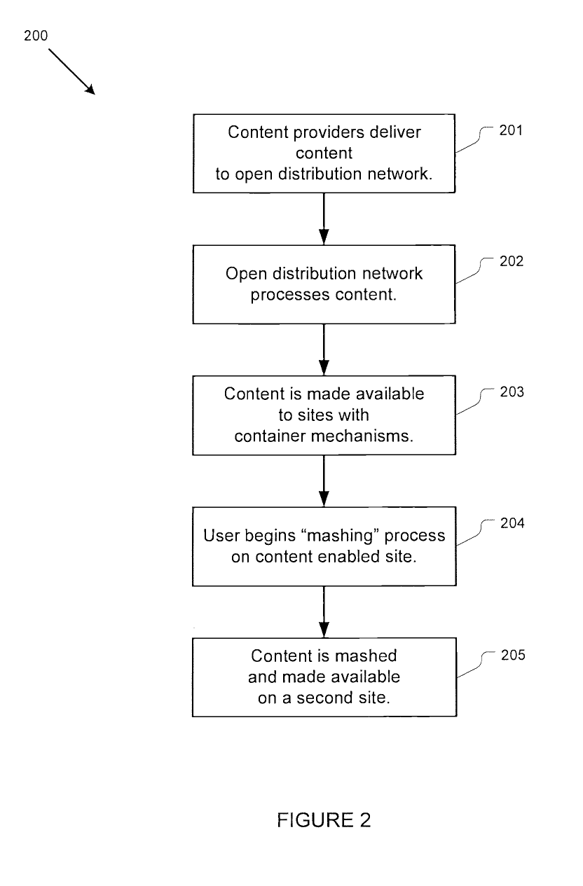

FIG. 2 is an exemplary illustration of a flowchart for providing, aggregating, expanding, and redistributing content according to the invention, in one regard.

In an operation 201, one or more content providers may deliver news materials in the form of content to an open distribution network. Content providers may deliver content to the open distribution network using the system architecture described in detail in FIG. 1. In an exemplary implementation, one or more content providers may deliver content to one or more Content Senders 102, 104, 106.

In an operation 202, content may be received and processed by the open distribution network. In various implementations, content may be subject to pre-processing by CPS 112 before being delivered to MMS 114 for storage in database 118. In various implementations, content may be subject to expansion by one or more of Content ID Subsystem 122, Content Structure Identification component 124, Content Enhancement components 132, 134, 136, and Content Matching component 140. Content that has been expanded may be relayed to MMS 114 for storage in database 118 to optimize the content.

In an operation 203, content may be made available to one or more sites. One or more workflows may be defined, and WMS 116 may add content to one or more existing playlists. Playlists may be published to a commercial news publishing web site such as, for example, an asset server interface or the NewsRoom management interface (described above), where a user may view the news items on the commercial site using Content Player 140.

In an operation 204, a user may elect to “Mash” a piece of content (by, for example, selecting a “Mash” button, link, or other user-selectable navigation or selection object associated with a piece of content) to enable the content to be virally distributed to various providers. In various implementations, a “Mash” selection object may comprise an object separate from the viewed content, or it may be displayed on (or embedded in) the content. “Mashing” provides users with, among other things, the capability of identifying content at one site (including the site of content redistributors), and creating new content associations that enable the content to be played on a third, possibly unrelated Web site. Viral distribution of content is the distribution of content directly from user to user or web site to web site without a distribution hierarchy.

In response to a user selection of a “Mash” selection object in operation 204, the “mashing” operation may commence in an operation 205. Mashing may commence with the identification of the content to be mashed on a first Web page, and the identification of a second Web page to which the identified content on the first Web page is to be mashed. After the content on the first Web page is identified, and the second Web page is identified, the mashing process may associate the identified content with the second identified Web page. Association may comprise producing a content play list, associating rules with the content, encrypting or otherwise cryptographically protecting content, playlists, and/or rules against tampering and/or privacy, embedding or aggregating content, or watermarking at least part of the content, either visibly or without noticeable trace.

Once the content has been associated with the second Web page, the mashing process may embed a link within the second identified Web page to Content Player 140 associated with a link to at least part of the content identified on the first Web site, and a “mash” button that causes the above steps to be performed again when selected. In various implementations, the link to the content may be provided indirectly. In various implementations, the “mashing” operation may occur in an automated manner when a user clicks a “Mash” button on the first Web page.

Process for Packaging Materials for Viral Redistribution

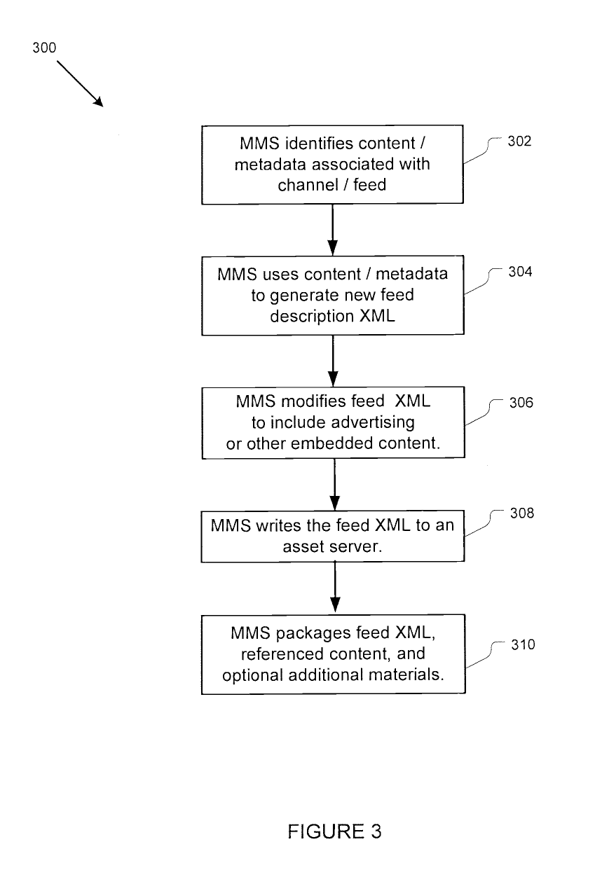

FIG. 3 is an exemplary illustration of a flowchart for providing pre-packaged materials for viral distribution, including both on-line and off-line use of virally distributed materials.

In operation 302, the MMS 114 identifies one or more pieces of content and metadata associated with a preconfigured distribution channel or content feed. The identification may occur when content is ingested into the system for the first time, or when one or more aspects of a piece of content or its associated metadata is changed. Examples of such changes are the inclusion of additional metadata such as from a scoring process and new or changed metadata from a system component such as content enhancement component 132. Other sources of new, changed, or deleted content or metadata can be added by those skilled in the art.

In operation 304, the MMS 114 uses each associated piece of content and metadata to generate a new piece of feed description XML. In various implementations, such as when content item is relatively small or of low value, an MMS 114 embeds the particular piece of content within the feed description XML.

In various implementations, in operation 306, the MMS 114 then modifies the feed XML to include specifications for advertising or other pieces of content that should be embedded within a feed. Implementations that utilize this step are typically provided when the pieces of content and advertising materials are to be viewed in an offline environment.

In operation 308, an MMS 114 writes the feed XML as a play list to an asset server 144, a cache, or location where it may be accessed by content players and other components of the system. The format of the feed XML may be changed to alternative formats such as RSS, SWF, or other formats as required for the uniquely identified play list may be encrypted, signed, or otherwise protected for privacy and integrity using techniques known to those skilled in the art. In various implementations, the play list is named using a unique ID associated with a feed.

In various implementations, in operation 310, an MMS 114 packages the feed XML, the referenced pieces of content (including pieces of content associated with advertisements), and optional additional materials such as a copies of a player and specifications for playing and reporting usage to uniquely identified container. The uniquely identified container may be encrypted, signed, or otherwise protected for privacy and integrity using techniques known to those skilled in the art. In some embodiments, the container is named using a unique ID associated with a feed. In operation 312, if a container was created, it is written to the asset server.

Process for Scoring Materials

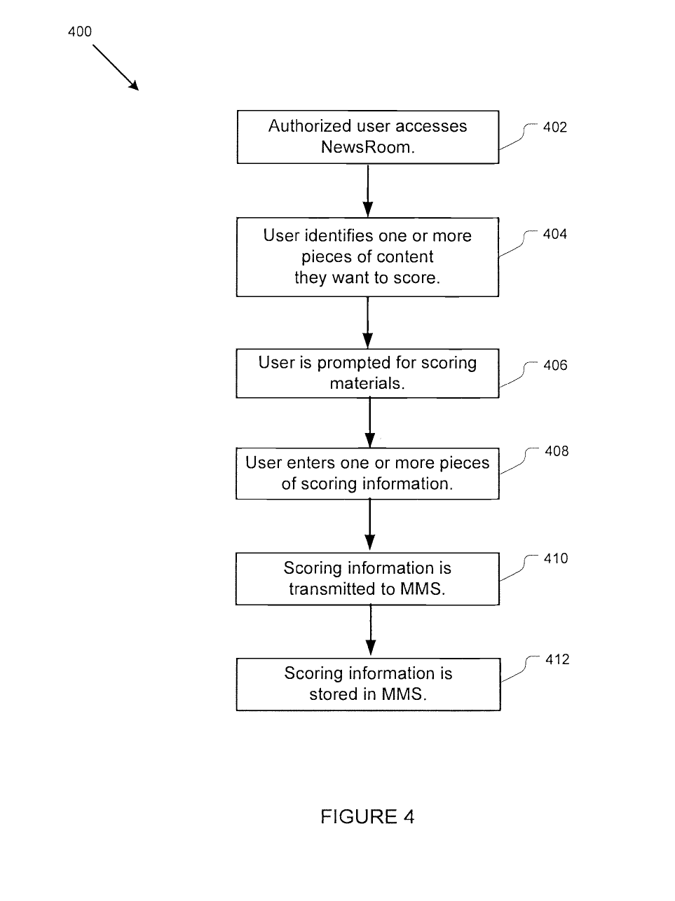

FIG. 4 is an exemplary illustration of a flowchart of the process for user scoring of materials. In an operation 402, an appropriately authorized user accesses the NewsRoom or other user interface, management, or content presentation application. In an operation 404, the user identifies one or more pieces of content that they desire to score. The pieces of content may be selected on a piece of content by piece of content basis, on a feed basis, or using other aspects of the user interface, management, or content presentation application. In an operation 406, the user is prompted for scoring materials using prompting information associated with the scoring configuration. In an operation 408, the user may enter one or more pieces of scoring information. In an operation 410, the scoring information may be transmitted to an MMS 114. In operation 412, the scoring information is stored in an MMS 114.

Implementations of the invention may be made in hardware, firmware, software, or any combination thereof. The invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described in the above disclosure in terms of specific exemplary aspects and implementations of the invention, and performing certain actions. However, those skilled in the art will recognize that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it is understood that it is within the knowledge of one skilled in the art to effect such feature, structure, or characteristic in connection with other aspects or implementations whether or not explicitly described. Thus, various changes and modifications may be made, without departing from the scope and spirit of the invention. The specification and drawings are to be regarded as exemplary only, and the scope of the invention is to be determined solely by the appended claims.

What is claimed is:

1. A method for collecting and distributing content, comprising:
receiving one or more items of content from a content provider;
packaging one or more of the received content items in a container, wherein at least one of the packaged content items is a viral content item associated with a mashing option; and
distributing the container of packaged content to a distributor, the packaged content presentable by the distributor using a player application that displays the mashing option when playing the viral content, wherein the viral content is distributed to a user when the user selects the displayed mashing option, wherein additional users can request distribution of the viral content from the distributor or the user by selecting the mashing option.

2. The method of claim 1, further comprising:
identifying one or more ingestion rules for processing the received content; and
associating the received content with one or more metadata elements and one or more usage rules based on the identified ingestion rules, the player application enforcing the associated usage rules when the playing the content.

3. The method of claim 2, the ingestion rules selected from a set consisting of: a definition of the metadata elements and the usage rules to be associated with the received content, a requirement for authentication information or query definitions to capture the received content, a required format for the received content, and a conversion specification for converting the received content into the required format.

4. The method of claim 2, the metadata elements selected from a set of consisting of: a unique provider identifier for identifying the content provider, one or more unique content identifiers for identifying an original source of the received content, one or more descriptive attributes for describing the received content, and one or more management attributes for managing the received content.

5. The method of claim 4, further comprising:
identifying the original source of the received content using the management attributes; and
associating the received content with a metadata element distinguishing the content provider from the identified source when the content provider is different from the identified source.

6. The method of claim 5, further comprising:
tracking usage of at least one of the distributed content and the distributed viral content; and
compensating least one of the original source and the content provider based on the tracked usage.

7. The method of claim 1, further comprising:
tracking usage of at least one of the distributed content and the distributed viral content; and
distributing additional content to at least one of the distributor and the user based on the tracked usage.

8. The method of claim 2, the usage rules selected from a set consisting of: availability dates, mashing restrictions, Uniform Resource Locator restrictions, network address restrictions, geographical restrictions, advertising restrictions, content branding restrictions, and content play restrictions.

9. The method of claim 8, the content play restrictions selected from a set consisting of: restrictions on playback of the received content, a restricted web site, restricted information on a web site, restricted content associated with the received content, and an authorization restriction.

10. The method of claim 2, the content items packaged in the containers based on one or more publication rules, the publication rules selected from a set consisting of: content to include in the container, advertising to include in the container, content to exclude from the container, and one or more of the metadata elements associated with the packaged content to include in the container.

11. A method for collecting and distributing content, comprising:
receiving one or more items of content from a content provider;
associating the received content with one or more usage rules;
packaging one or more of the associated content items in a container; and
distributing the container of packaged content to a distributor, the packaged content presentable by the distributor using a player application that enforces the associated usage rules when the playing the packaged content.

12. The method of claim 11, the usage rules selected from a set consisting of: availability dates, mashing restrictions, Uniform Resource Locator restrictions, network address restrictions, geographical restrictions, advertising restrictions, content branding restrictions, and content play restrictions.

13. The method of claim 12, the content play restrictions selected from a set consisting of: restrictions on playback of the received content, a restricted web site, restricted information on a web site, restricted content associated with the received content, and an authorization restriction.

14. A method for collecting and distributing content, comprising:
receiving one or more items of content from a content provider, the received content including one or more metadata elements;
determining an original source of the received content using the metadata elements;
distributing the received content to one or more distributors, at least one of the distributed content items associated with a mashing option, wherein the distributed content is virally distributed to a user when the user selects the mashing option;
tracking usage of at least one of the distributed content and the virally distributed content; and
compensating at least one of the determined original source and the content provider based on the tracked usage

15. The method of claim 14, further comprising distributing additional content to at least one of the distributor and the user based on the tracked usage.

16. The method of claim 14, further comprising associating the received content with a metadata element distinguishing the content provider and the original source when the content provider is different from the determined original source.

17. The method of claim 14, the metadata elements selected from a set consisting of: a unique provider identifier for identifying the content provider, one or more unique content identifiers for identifying the original source, a revision identifier for identifying the received content as a revised content item, a republication identifier for identifying the received content as a republished content item, linking information for referencing an original version of the revised or the republished content, and one or more descriptive attributes for describing the received content.

18. The method of claim 17, further comprising:
initiating a content search when the metadata elements do not include the linking information for revised or republished content, the initiated search identifying content having one or more metadata elements matching the metadata elements of the received content, wherein at least one of the original source or the original version is determined based on results of the identified content.

19. A method for collecting and distributing content, comprising:
receiving one or more items of content from a content provider;
assigning a score to the received content based on a type of the received content, an age of the received content, and the content provider;
packaging one or more of the received content items in a container based on the assigned score; and
distributing the container of packaged content to a distributor, the packaged content presentable to users by the distributor using a player application.

20. The method of claim 19, wherein assigning the score based on the type includes assigning a first ranking to video content, assigning a second ranking to textual content, assigning a third ranking to image content, and assigning a fourth ranking to audio content, wherein the first ranking is a highest ranking and the fourth ranking is the lowest ranking.

21. The method of claim 19, wherein assigning the score based on the age includes assigning a ranking based on a number of hours since creation of the received content, wherein higher age rankings are assigned to lower numbers of hours.

22. The method of claim 19, wherein assigning the score based the content provider includes assigning a first ranking to commercial content providers, assigning a second ranking to mid-level content providers, and assigning a third ranking to other content providers, wherein the first ranking is a highest ranking and the third ranking is the lowest ranking.

23. The method of claim 19, wherein assigning the score is further based on at least one scoring rule, the scoring rule assigning weights to the type, the age, and the content provider.

24. The method of claim 19, wherein assigning the score is further based on editor scores and/or user scores for the received content, the editor and/or the user scores based on an importance of the received content, a viral quality of the received content, an exclusivity of the received content, and a relationship between the received content and other content.

25. The method of claim 24, wherein assigning the score is further based on at least one scoring rule, the scoring rule assigning weights to the type score, the age score, the content provider score, the importance ranking, the viral quality ranking, the exclusivity ranking, and the relatedness ranking.

26. The method of claim 19, the received content associated with one or more descriptive attributes for describing the received content, wherein packaging the received content in the container includes scoring identifying relationships among the received content using the descriptive attributes.

27. A system for distributing content, comprising:
at least one server; and
at least one data repository that stores one or more items of content received from a content provider, wherein the server is operable to:
package one or more of the received content items in a container, wherein at least one of the packaged content items is a viral content item associated with a mashing option; and
distribute the container of packaged content to a distributor, the packaged content presentable by the distributor using a player application that displays the mashing option when playing the viral content, wherein the viral content is persistently linked to the server.
